(19) United States
(12) Patent Application Publication
(10) Pub. No.: US 2003/0085926 A1
(43) Pub. Date: May 8, 2003

(54) Display system and method of adjusting display settings of a display device

(76) Inventors: Ingrid Emilienne Joanna Rita Heynderickx, Eindhoven (NL); Abraham Karel Riemens, Eindhoven (NL)

Correspondence Address: U.S. Philips Corporation, 580 White Plains Road, Tarrytown, NY, 10591, US

(21) Appl. No.: 10/274,213

(22) Filed: Oct. 18, 2002

(30) Foreign Application Priority Data
Oct. 23, 2001 (EP) 01204023.4

(51) Int. Cl. G09G 5/00

(52) U.S. Cl. 345/765

(57) ABSTRACT

In a method of adjusting display settings defining the appearance of a main picture (11) generated by a display device on a screen (10) and dependent on user preference, a choice of options for a value or combination of values for the settings is made available for selection by a user of the device. The selected option is adopted as the new display settings defining the appearance of the main picture (11), upon confirmation by the user. A sample picture (13, 15-18), specifically adapted for displaying the effects of different values of the settings and defined by the selected option, is displayed on the screen (10) before confirmation. The sample picture (13, 15-18) is specific to the device and is generated from video data stored in memory (9) in the display device.

The present invention relates to a method of adjusting display settings defining the appearance of a main picture generated by a display device on a screen and dependent on user preference, wherein a choice of options for a value or combination of values for the settings is made available for selection by a user of the device, and the selected option is adopted as the new display settings defining the appearance of the main picture, upon confirmation by the user, wherein a sample picture, specifically adapted for displaying the effects of different values of the settings and defined by the selected option, is displayed on the screen before confirmation. The invention further relates to a display system comprising a video signal receiver; a video signal processor, connected to the receiver, for processing the signal according to display settings dependent on user preference; user controls for selecting options for a value or combination of values for the settings, and for confirming the selected option to change the settings; and a projector, capable of generating a main picture on a screen from the processed video signal, wherein the display device is programmed to display a sample picture before confirmation, specifically adapted for displaying the effects of different values of the settings and defined by the selected option.

Such a method and device are known, e.g. from EP 0 844 788 A3. It discloses a method and apparatus for adjusting television display controls using a web browser. A picture adjustment screen is displayed on a display device comprised in a client system. The client system is in communication with at least one server system. Instructions for adjustment of one or more picture adjustment controls of the display device are further displayed. A reference test pattern is displayed on the picture adjustment screen. The reference test pattern contains an attribute corresponding to a display characteristic. It is provided on a home page made available by way of browser software. The home page is obtained from the World-Wide Web or built-in to the web browser or service.

Although the use of an attribute corresponding to a display characteristic allows better adjustment of the display settings, the result is still not optimal, since the attribute is a general attribute. It has to be appropriate to each display device that can be connected to the set-top box. In addition, the use of a web page provided instead of the normal signal to the display device, means the adjusted settings are tailored to the display of web pages. Moreover, adjustment is cumbersome, since the user of the display device has to enter the WebTV home page and navigate to the set-up screens by clicking onto the hypertext anchors provided.

It is an object of the present invention to provide a method and display system of the kind mentioned above that are easy to use and adapted to adjusting the settings for viewing a television signal.

Accordingly, the method according to the invention is characterised in that the sample picture is specific to the device and is generated from video data stored in memory in the display device.

Thus, the sample picture can be adapted to the display device concerned. Instead of having to be suitable for a wide range of display devices, as is the case when the sample picture is provided from an external source, the sample picture can have features and dimensions appropriate to the screen on which it is to be displayed.

In the preferred embodiment of the invention the sample picture is displayed in a window superimposed on the main picture and of smaller dimensions than the main picture. Thus, the viewer can simultaneously view the main picture in the background, missing as little as possible of the actual program.

The display system according to the invention is characterised in that the display system further comprises a picture in picture processor, for generating the sample picture and superimposing it on the main picture, and memory, storing video data, wherein the display device is programmed to generate the sample picture from the video data.

Thus, the sample picture can be specifically adapted to the display system concerned, for example by having dimensions and fineness of detail appropriate to the screen size. By using a picture in picture generator, the sample picture can be superimposed upon the main picture. The user of the system can then immediately return to the main picture upon confirmation of the adjustment to the display settings.

The invention will now be explained in further detail with reference to the attached drawings, of which

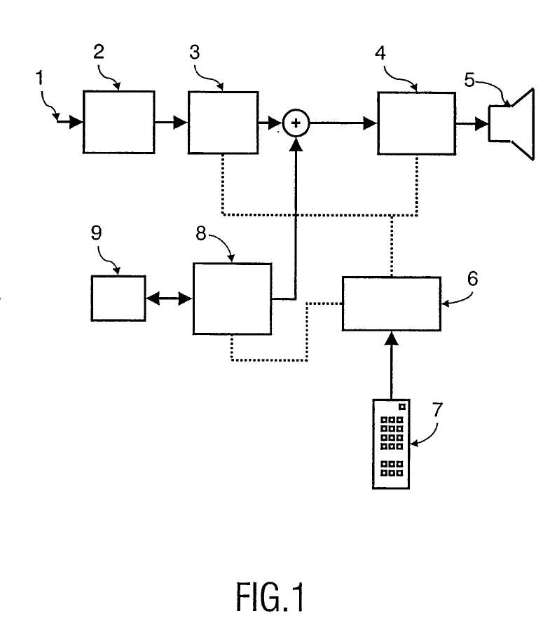

FIG. 1 shows a very schematic diagram of components of a display system according to the invention,

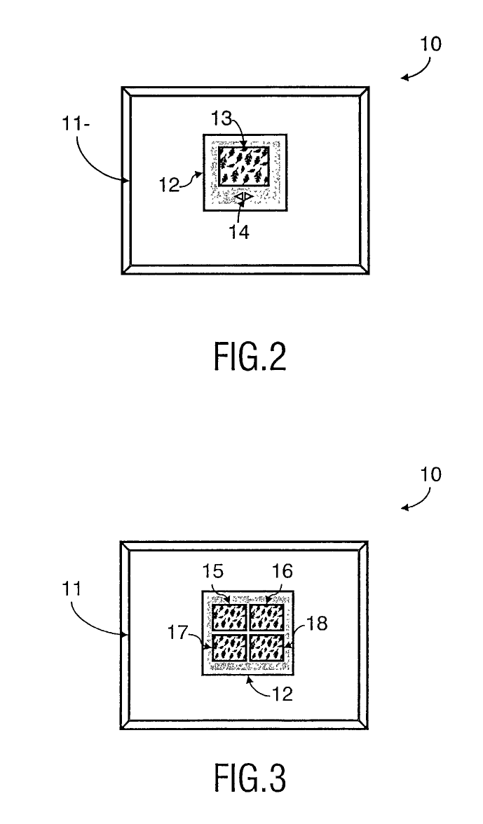

FIG. 2 shows a view of a screen according to one embodiment of the invention, and

FIG. 3 shows a view of a screen according to another embodiment of the invention.

FIG. 1 shows very schematically a partial block diagram of an embodiment of a display system according to the invention. Components that are not of importance to the invention have been left out. Blocks in the block diagram do not necessarily correspond to physical components in a display system.

Examples of actual display systems in which the invention can be implemented are TV sets, computer monitors, image projectors, etc. In each of these systems, a video signal is taken as input and converted to a picture on a screen. The screen can be a cathode ray tube, a liquid crystal display, or a white board from which a projected picture is reflected.

A video source signal 1 is provided to a video signal receiver 2. For example, it can be a television signal provided through a cable connection, an aerial, satellite link, or video recorder. In these cases, the receiver 2 would comprise a tuning circuit, to select one channel for display. The video signal is passed to a video processor 3, where it is decoded, if necessary and processed according to a number of display parameters, which can include image enhancement features. For example, the contrast can be increased, noise can be removed, brightness can be increased, etc. The processed signal is then passed to a display driver 4, which converts the signal to a signal suitable for a projector 5. For example, if the projector 5 is part of a cathode ray tube, then the signal from the display driver 4 to the projector 5 will comprise three colour intensity signals. The picture can further be adjusted through processing of the signals in the display driver 4. For example the brightness can be increased through amplification of the signal.

The parameters defining the appearance of the main picture generated by the projector 5 on a screen are collectively termed the display settings. At any one time, each parameter is set at one of a range of optional values. Since users have different preferences as to how they would like the picture to appear, means are provided for adjusting the settings.

In the block diagram of FIG. 1 the means for adjusting the settings are represented by a system controller 6 and a user control unit 7. In a TV or projector system, for example, these would typically comprise a remote control unit and receiver and a microcontroller unit for translating user commands into instructions to the various other components of the set. In a computer monitor, the user control unit 7 would be integrated into the monitor as buttons, for example, or commands could be passed through the computer keyboard. Other variants are possible, as will be apparent to those skilled in the art. The links through which instructions are passed from the system controller 6 to the receiver 2, the video processor 3 and display driver 4, are represented by dotted lines. In a specific device, a data bus, like the IIC bus in televisions, can be used to pass instructions and replies between components of the system.

FIG. 1 further shows a picture-in-picture processor 8, with access to memory 9, and/or comprising memory, usefully of the random access type, itself. The picture-in-picture processor 8 is capable of generating a window, which can be superimposed on the main picture on a screen. This is done by adding the signal for the window to the output of the video processor 3, before it is passed to the display driver 4. The skilled person will understand that this is easily achieved in a digital display system, where the output of both the video processor 3 and picture-in-picture processor 8 consist of digital signals. The composite signal is then converted to analogue form, if necessary, in the display driver 4. Means of communication between the system controller 6 and the picture-in-picture processor 8 are also provided for.

When a user wishes to adjust the display settings defining the appearance of the main picture on the screen. An appropriate command is issued through the user control unit 7 to the system controller 6. A choice of options for a value or combination of values for those settings the user wishes to adjust is made available in a manner that will be described below. The user can use the control unit 7 to select one of the options. Upon explicit or implicit confirmation of the selected option, the values are changed to those represented by that option.

According to the invention, the picture-in-picture processor 8 generates a sample picture from video data stored in memory 9. The sample picture is therefore specific to the system. The sample picture is also specific to the settings selected for adjustment. For example, if the settings to be changed concern the level of noise reduction, the sample picture is a specific picture selected or designed to exhibit the effect of changes in that parameter in the best possible way. Thus, the user is made aware of the fact that an increased level of noise reduction can result in the introduction of artefacts in the picture, so that extreme levels of noise reduction are not always desirable. The user can strike a balance between reduced noise and an increased number of artefacts according to his preference using the system according to the invention.

The sample picture is inserted in a window, possibly with other graphical elements, such as menu buttons and explanatory text. The window is smaller than the main picture and superimposed on the main picture, for display on a screen, using the projector 5.

FIG. 2 shows a view of a screen 10 as it appears in one embodiment of the invention. A main picture 11, left blank in FIG. 2, is projected on the screen 10 in the background, filling the entire screen 10. Superimposed on the main picture 11 is a window 12 of smaller dimensions, generated by the picture-in-picture processor 8. The window 12 comprises a single sample picture 13 and menu buttons 14.

The appearance of the sample picture 13 is defined by the option for the display settings currently selected by the user. The user can select another option, by selecting one of the buttons 14 using the user control unit 7 to pass the relevant commands. In this way, the user can cycle through the available options for the display settings. Each time a different option is selected, the appearance of the sample picture 13 changes, to display the effect the selected option has on the appearance of a picture on the screen 10.

FIG. 3 shows a view of the screen 10 as it appears in a different embodiment of the invention. The main picture 11 is again present in the background. The window 12 is also superimposed on the main picture 11, but this time, a plurality of sample pictures 15-18 is displayed in the window. The appearance of each of these sample pictures 15-18 is defined by a different option for the display settings, in order that the user can easily compare them. This can be of advantage, if the difference between the various options is small, or is not on a simple increasing or decreasing scale, such as will often be the case if the option defines a number of values for a combination of display parameters.

In case the desired level of noise reduction is to be selected, the trade-off between suppression of noise and introduction of artefacts can be seen in one glance. Again, the user selects one of the options using the control unit 7 and confirms the selection, in a single step or in multiple steps.

As mentioned above, the sample pictures 13, 15-18 are generated by the picture-in-picture processor 8 from video data stored in memory 9. In one preferred embodiment, adjustment of those display settings that affect the appearance of very dynamic pictures, is facilitated by providing sample pictures 13, 15-18 comprising a sequence of images. To avoid taking up too much storage space in memory 9, these a plurality of images can be generated from one source image encoded in the video data stored in memory 9. For example, the sequence of moving images could be generated from one source image, which is reconfigured in some way to generate each image in the sequence.

In a similar fashion, each of the sample pictures 15-18 can be generated from one source image, processed to reflect the different options of the display settings. Where one source image is appropriate for displaying the effect of more than one type of display settings, e.g. both contrast and brightness, it can be used to provide the window 12 for adjustment of each of these.

This saves on non-volatile memory, since the source image can be stored in permanent memory and the images created from the source image can be temporarily stored in random access memory. For example, the picture-in-picture processor 8 can have random access memory in which it temporarily stores images, to allow for fast generation of sample pictures 13, 15-18. Memory 9 can then consist of non-volatile memory.

In another preferred embodiment that saves on permanent memory, the stored video data is in a compressed format and the video data is decompressed in the process of generating the sample pictures 13, 15-18. Again, the compressed video data can be stored in memory 9, whereas the decompressed images can be temporarily stored in RAM.

It will be obvious to those skilled in the art that the invention is not limited to the above-described embodiments, which can be varied in a number of ways within the scope of the attached claims. For example, in an actual system, components and functions can be concentrated in one chip or in a couple of chips, connected by a bus, like the IIC bus for television receivers. Likewise, components can share memory or a processor. Various varieties of menus and window lay-outs are possible, as long as they comprise a sample picture as described above.

1. Method of adjusting display settings defining the appearance of a main picture (11) generated by a display device on a screen (10) and dependent on user preference, wherein
a choice of options for a value or combination of values for the settings is made available for selection by a user of the device, and the
selected option is adopted as the new display settings defining the appearance of the main picture (11), upon confirmation by the user, wherein
a sample picture (13, 15-18), specifically adapted for displaying the effects of different values of the settings and defined by the selected option, is displayed on the screen (10) before confirmation, characterised in that the sample picture (13, 15-18) is specific to the device and is generated from video data stored in memory (9) in the display device.

2. Method according to claim 1, wherein the sample picture (13, 15-18) is displayed in a window superimposed on the main picture (11) and of smaller dimensions than the main picture (11).

3. Method according to claim 1 or 2, wherein a single sample picture (13) is displayed, and the appearance of the sample picture (13) is changed upon selection of an option.

4. Method according to claim 1 or 2, wherein a finite number of available options is offered for selection by the user and a plurality of further sample pictures (15-18), each defined by one of the available options, are displayed simultaneously, for selection by the user.

5. Method according to any one of the preceding claims, wherein the sample picture(s) (13, 15-18) comprise(s) a sequence of images, in order to demonstrate the effect of the settings on moving images.

6. Method according to any one of the preceding claims, wherein a plurality of images for a sample picture (13, 15-18) are generated from one source image comprised in the video data.

7. Method according to any one of the preceding claims, wherein the stored video data is in a compressed format, and the video data is decompressed in the process of generating the sample picture (13, 15-18).

8. Display system comprising
a video signal receiver (2);
a video signal processor (3, 4), connected to the receiver (2), for processing the signal according to display settings dependent on user preference;
user controls (6, 7, 14) for selecting options for a value or combination of values for the settings, and for confirming the selected option to change the settings; and
a projector (5), capable of generating a main picture (11) on a screen (10) from the processed video signal, wherein the display device is programmed to display a sample picture (13, 15-18) before confirmation, specifically adapted for displaying the effects of different values of the settings and defined by the selected option, characterised in that the display system further comprises a picture in picture processor (8), for generating the sample picture (13, 15-18) and superimposing it on the main picture (11), and memory (9), storing video data, wherein the display device is programmed to generate the sample picture (13, 15-18) from the video data.

9. Display system according to the preceding claim, wherein the memory (9) comprises random access memory and non-volatile memory storing a source image, wherein the display device is programmed to generate from the source image, and store in the random access memory, a plurality of sample images for display in the sample picture (13, 15-18).

10. Computer program loadable into a display device comprising a programmable processor and memory, so that the display device programmed in this way is capable of or adapted to carrying out a method according to any one of claims 1-7.
